(19) United States
(12) Patent Application Publication
(10) Pub. No.: US 2024/0162978 A1
(43) Pub. Date: May 16, 2024

(54) METHODS FOR SATELLITE HARD FEEDER LINK SWITCHOVER

(71) Applicant: Lenovo (Singapore) Pte. Ltd., New Tech Park (SG)

(72) Inventors: Sher Ali Cheema, Ilmenau (DE); Ali Ramadan Ali, Kraiburg am Inn (DE); Majid Ghanbarinejad, Chicago, IL (US); Ankit Bhamri, Rödermark (DE)

(21) Appl. No.: 18/550,108

(22) PCT Filed: Mar. 9, 2022
(86) PCT No.: PCT/IB2022/052121

§ 371 Date: Sep. 11, 2023

Related U.S. Application Data
(60) Provisional application No. 63/158,790, filed on Mar. 9, 2021.

(51) Int. Cl. H04B 7/185; H04W 36/00; H04W 36/08

(52) U.S. Cl. CPC H04B 7/18519; H04W 36/0085; H04W 36/083

(57) ABSTRACT

Apparatuses, methods, and systems are disclosed for handling satellite hard feeder link switchover. One apparatus includes a processor and a transceiver that receives a configuration from a mobile communication network, the configuration indicating a transition period required by a satellite connected to a first gateway for feeder link switchover to a second gateway. The processor suspends communication with the mobile communication network at the transition time and resumes communication with the mobile communication network after expiry of the transition duration.

### CROSS-REFERENCE TO RELATED APPLICATIONS

This application claims priority to U.S. Provisional Patent Application No. 63/158,790 entitled “FAST SYNCHRONIZATION FOR SATELLITE HARD FEEDER LINK SWITCHOVER” and filed on Mar. 9, 2021 for Sher Ali Cheema, Ali Ramadan Ali, Majid Ghanbarinej al, and Ankit Bhamri, which application is incorporated herein by reference.

### FIELD

The subject matter disclosed herein relates generally to wireless communications and more particularly relates to fast synchronization for satellite hard feeder link switchover in non-terrestrial networks (“NTNs”).

### BACKGROUND

For operation in Non-Terrestrial Networks (“NTNs”), where satellites are in the communication path between user equipment (“UE”) and core network (“CN”), satellite mobility requires switchover from one NTN gateway to another.

### BRIEF SUMMARY

Disclosed are procedures for handling satellite hard feeder link switchover. Said procedures may be implemented by apparatus, systems, methods, or computer program products.

One method at a User Equipment (“UE”) for handling satellite hard feeder link switchover includes receiving a configuration from a mobile communication network, where the network comprises a satellite, a first gateway to which the satellite is connected, and a second gateway to which the satellite is to connect in the future. Here, the configuration indicates a transition period required by the satellite connected to the first gateway for feeder link switchover to the second gateway, the transition period defined by a transition time and a transition duration. The method includes suspending communication with the mobile communication network at the transition time and resuming communication with the mobile communication network after expiry of the transition duration.

Another method at a UE for handling satellite hard feeder link switchover includes receiving a first configuration from a mobile communication network, where the network comprises a satellite, a first gateway to which the satellite is connected, and a second gateway to which the satellite is to connect in the future. Here, the first configuration indicates a transition period required by the satellite connected to the first gateway for feeder link switchover to the second gateway, the transition period defined by a transition time and a transition duration. The method includes receiving a second configuration from the network, said second configuration indicating a threshold time before the transition time and initiating a handover procedure to a new cell when the threshold time before the transition time is reached, where the new cell is not associated with the first satellite.

One method at a RAN for handling satellite hard feeder link switchover includes transmitting a configuration to at least one UE, the configuration indicating a transition period required by the satellite connected to the first gateway for feeder link switchover to the second to gateway, the transition period defined by a transition time and a transition duration. The method includes suspending communication with the at least one UE at the transition time and resuming communication with the at least one UE after expiry of the transition duration.

Another method at a RAN for handling satellite hard feeder link switchover includes transmitting a first configuration to at least one UE, the first configuration indicating a transition period required by the satellite connected to the first gateway for feeder link switchover to the second gateway, the transition period defined by a transition time and a transition duration. The method includes transmitting a second configuration to the at least one UE, said second configuration containing a threshold time before the transition time. The method includes handing over the at least one UE to a new cell when the threshold time before the transition time is reached, where the new cell is not associated with the first satellite.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for handling satellite hard feeder link switchover;

FIG. 2A is a diagram illustrating one embodiment of a feeder link switchover for a Low-Earth Orbit (“LEO”) satellite in NTN at a first point in time prior to the switchover;

FIG. 2B is a diagram illustrating one embodiment of the feeder link switchover of FIG. 2A at a second point in time after the switchover;

FIG. 3A is a diagram illustrating another embodiment of a feeder link switchover for LEO satellite in NTN at a first point in time prior to the switchover;

FIG. 3B is a diagram illustrating one embodiment of the feeder link switchover of FIG. 3A at a second point in time during the switchover;

FIG. 3C is a diagram illustrating one embodiment of the feeder link switchover of FIG. 3A at a third point in time after the switchover;

FIG. 4A is a diagram illustrating an additional embodiment of a feeder link switchover for LEO satellite in NTN at a first point in time prior to the switchover;

FIG. 4B is a diagram illustrating one embodiment of the feeder link switchover of FIG. 4A at a second point in time after the switchover;

FIG. 5A is a diagram illustrating one embodiment of a network architecture with a single RAN node and multiple NTN gateways prior to feeder link switchover;

FIG. 5B is a diagram illustrating the network architecture of FIG. 5A after feeder link switchover;

FIG. 6A is a diagram illustrating one embodiment of feeder link switchover for earth-fixed cells at a first point in time prior to feeder link switchover;

FIG. 6B is a diagram illustrating one embodiment of the feeder link switchover of FIG. 6A at a second point in time after the feeder link switchover;

FIG. 7 is a diagram illustrating one embodiment of a 3GPP New Radio (“NR”) protocol stack;

FIG. 8 is a block diagram illustrating one embodiment of a user equipment apparatus that may be used for handling satellite hard feeder link switchover;

FIG. 9 is a block diagram illustrating one embodiment of a network apparatus that may be used for handling satellite hard feeder link switchover;

FIG. 10 is a flowchart diagram illustrating one embodiment of a first method for handling satellite hard feeder link switchover;

FIG. 11 is a flowchart diagram illustrating one embodiment of a second method for handling satellite hard feeder link switchover;

FIG. 12 is a flowchart diagram illustrating one embodiment of a third method for handling satellite hard feeder link switchover; and

FIG. 13 is a flowchart diagram illustrating one embodiment of a fourth method for handling satellite hard feeder link switchover.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for fast synchronization for satellite hard feeder link switchover. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In 3GPP NTN Rel-16 and Rel-17, hard feeder link switch and soft feeder link switch are supported for non geo stationary satellites systems. In hard feeder link switch, the satellite needs to disconnect from the old gateway and connect with the new gateway after some transition time. This will require all UEs in a cell to make access to the serving cell again. As all users will try to resynchronize with the new serving cell simultaneously, this will result in a large amount of signaling messages over a short period of time. Especially, due to large cell size and more users as compared to terrestrial networks in NTN, there would be a lot of preamble collisions which will eventually result in performance degradation and unsmooth transition.

As compared to the terrestrial networks, where handover is generally based on the UE mobility, handover due to hard feeder link switch is due to the movement of satellites which is known. This information may be utilized to enhance the physical layer signaling framework to ensure a reliable transition and avoid performance degradation.

Described here are solutions for fast synchronization for satellite hard feeder link switchover. The solutions may be implemented by apparatus, systems, methods, or computer program products. The disclosure presents physical layer signaling enhancements to avoid signaling jamming/collisions in case of hard feeder link switchover for non-geo stationary transparent satellites. The solutions for feeder link switchover may be applicable to both earth-fixed cells and earth-moving cells.

Said solutions include novel signaling and procedures, including: A) indication of satellite transition time and assistance information through UE dedicated RRC signaling, common Radio Resource Control (“RRC”) signaling, Medium Access Control (“MAC”) control element (“CE”), Downlink Control Information (“DCI”) message, or some combination thereof for earth-fixed cells; B) indication of satellite transition time and assistance information for a group of UEs through UE-dedicated or common RRC signaling with location information, DCI message, group-common DCI (“GC-DCI”) message, or some combination thereof for earth-moving cells; C) group-based random-access procedure (“RACH procedure”) with a time allocation to avoid collisions and fast resynchronization procedure after feeder link switchover happens; and D) handover to neighboring cell via single or plurality of satellite link before the feeder link switchover starts to avoid link failure.

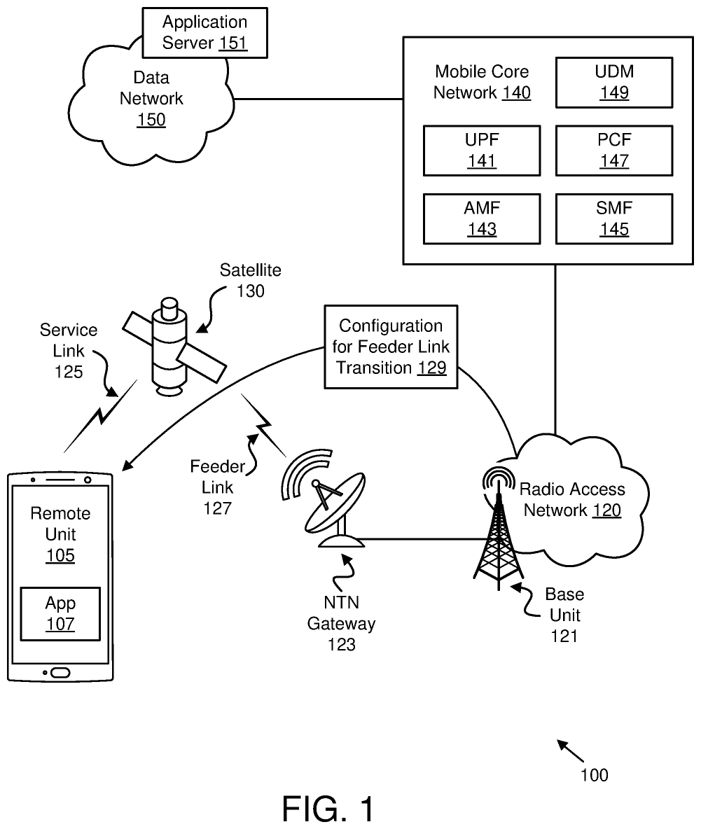

FIG. 1 depicts a wireless communication system 100 for handling satellite hard feeder link switchover, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates via a satellite 130 using wireless communication links, e.g., service link(s) 125 and feeder link(s) 127. As depicted, the mobile communication network includes an “on-ground” base unit 121 and non-terrestrial network (“NTN”) gateway 123 which serves the remote unit 105 via satellite access.

Even though a specific number of remote units 105, base units 121, wireless communication links, RANs 120, satellites 130, NTN gateways 123 (e.g., satellite ground/earth devices), and mobile core networks 140 are depicted in FIG. 1, one of skill in the art will recognize that any number of remote units 105, base units 121, wireless communication links, RANs 120, satellites 130, NTN gateways 123, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. In some embodiments, the remote units 105 communicate in a non-terrestrial network via UL and DL communication signals between the remote unit 105 and a satellite 130. In certain embodiments, the satellite 130 may communicate with the RAN 120 via an NTN gateway 123 using UL and DL communication signals between the satellite 130 and the NTN gateway 123. The NTN gateway 123 may communicate directly with the base units 121 in the RAN 120 to relay UL and DL communication signals.

Furthermore, the UL and DL communication signals may be carried over the wireless communication links during at least a portion of their path between RAN 120 and the remote unit 105. In the depicted embodiment, the wireless communication link between the remote unit 105 and satellite 130 comprises a service link 125, while the wireless communication link between the satellite 130 and the base unit 121 comprises a feeder link 127. However, in other embodiments, the satellite(s) and NTN gateways may be deployed between the base unit 121 or RAN 120 and the mobile core network 140, e.g., similar to wireless backhaul links.

The RAN 120 is an intermediate network that provides the remote units 105 with access to the mobile core network 140. In various embodiments, the UL communication signals may comprise one or more uplink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”).

Moreover, the satellite 130 provides a non-terrestrial network allowing the remote unit 105 to access the mobile core network 140 via satellite access. While FIG. 1 depicts a transparent NTN system where the satellite 130 repeats the waveform signal for the base unit 121, in other embodiments the satellite 130 (for regenerative NTN system), or the NTN gateway 123 (for alternative implementation of transparent NTN system) may also act as base station, depending on the deployed configuration.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW,” not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120. Note that in the NTN scenario certain RAN entities or functions may be incorporated into the satellite 130. For example, the satellite 130 may be an embodiment of a Non-Terrestrial base station/base unit.

The base units 121 may serve a number of remote units 105 within a serving area, for example, a cell or a cell sector, via a wireless communication link. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links. The wireless communication links may be any suitable carrier in licensed or unlicensed radio spectrum. The wireless communication links facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR,” also referred to as “Unified Data Repository”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to control plane functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the Fifth Generation Core network (“5GC”). When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

In various embodiments, the remote unit 105 receives a configuration 129 from the base unit 121. As described in greater detail below, the configuration 129 indicates a transition period required by the satellite 130 for hard feeder link switchover, i.e., from a first NTN gateway 123 to a second NTN gateway 123. The transition period is defined by a start time (also referred to as “transition time”) and a transition duration. The wireless communication system 100 may employ one or more of the below described solutions to mitigate the impact of hard feeder link switchover.

While FIG. 1 depicts components of a 5G RAN and a 5G core network, the described embodiments for handling satellite hard feeder link switchover apply to other types of communication networks and RATs, including IEEE 802.11 variants, Global System for Mobile Communications (“GSM,”, i.e., a 2G digital cellular network), General Packet Radio Service to (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/20 base unit, but it is replaceable by any other radio access node, e.g., gNB, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for handling satellite hard feeder link switchover.

During NTN operation, it may become necessary to switch the feeder link (i.e., Satellite Radio Interface (“SRI”)) between different NTN gateways (“NTN-GWs”) toward the same satellite. This may be due to, e.g., maintenance, traffic offloading, or due to the satellite moving out of visibility with respect to the current NTN-GW. The switchover should be performed without causing service disruption to the served UEs. This can be done in different ways according to the NTN architecture option deployed.

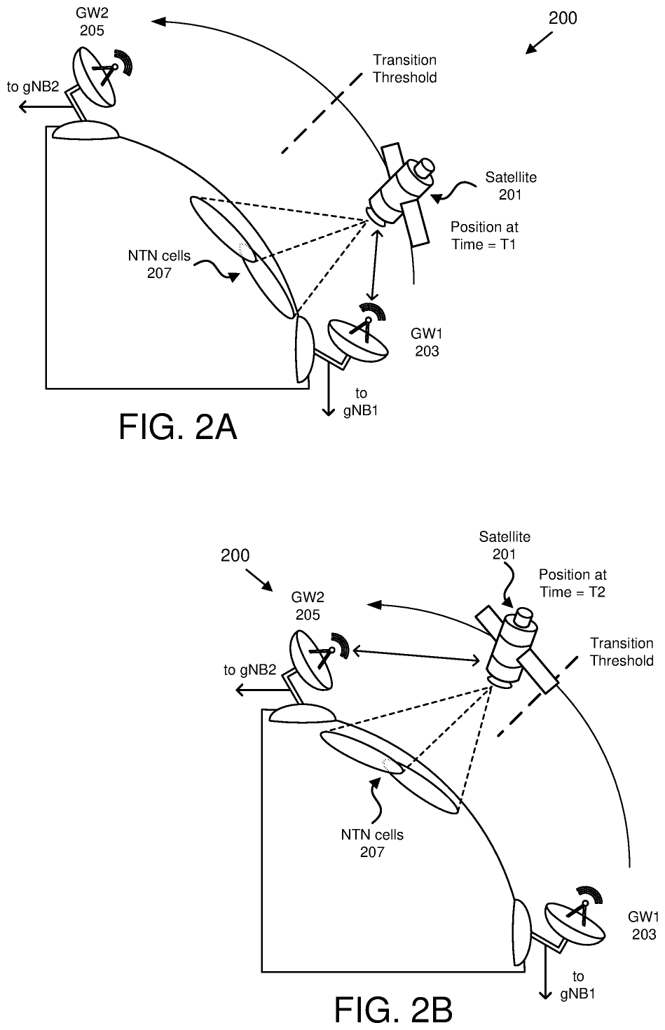

FIGS. 2A-2B depict an exemplary NTN 200 during feeder link switchover for transparent low-Earth orbit (“LEO”) NTN, i.e., due to the satellite moving out of visibility with respect to the current NTN-GW. The NTN 200 includes a satellite 201, a first NTN-GW (denoted “GW1” 203), and a second NTN-GW (denoted “GW2” 205). As seen from the Figures, in the transparent case the RAN node (i.e., gNB) is on earth thus the feeder link switchover will also involve a switch from a first RAN node (depicted as “gNB1”) to a second RAN node (depicted at “gNB2”).

FIG. 2A depicts the NTN 200 at a moment in time (i.e., ‘T1’) prior to the feeder link switchover, according to embodiments of the disclosure. At the time ‘T1’, the satellite 201 is connected to the GW1 203 via a first feeder link serving the first RAN node (i.e., gNB1).

FIG. 2B depicts the NTN 200 at a moment in time (i.e., ‘T2’) after to the feeder link switchover, according to embodiments of the disclosure. At the time ‘T2’, the satellite 201 has moved past the transition threshold and has established a feeder link with the GW2 205 serving a second RAN node (i.e., gNB2).

If the satellite 201 can be served by one feeder link at a time it means that with Rel-15 NR assumptions the RRC connection for all UEs served by the first RAN node (i.e., gNB1 via GW1 203) needs to be dropped. After the second RAN node (i.e., gNB2 via GW2 205) takes over, the UEs may be able to find the reference signals corresponding to the second RAN node and perform initial access on an NTN cell 207 belonging to the second RAN node (i.e., gNB2).

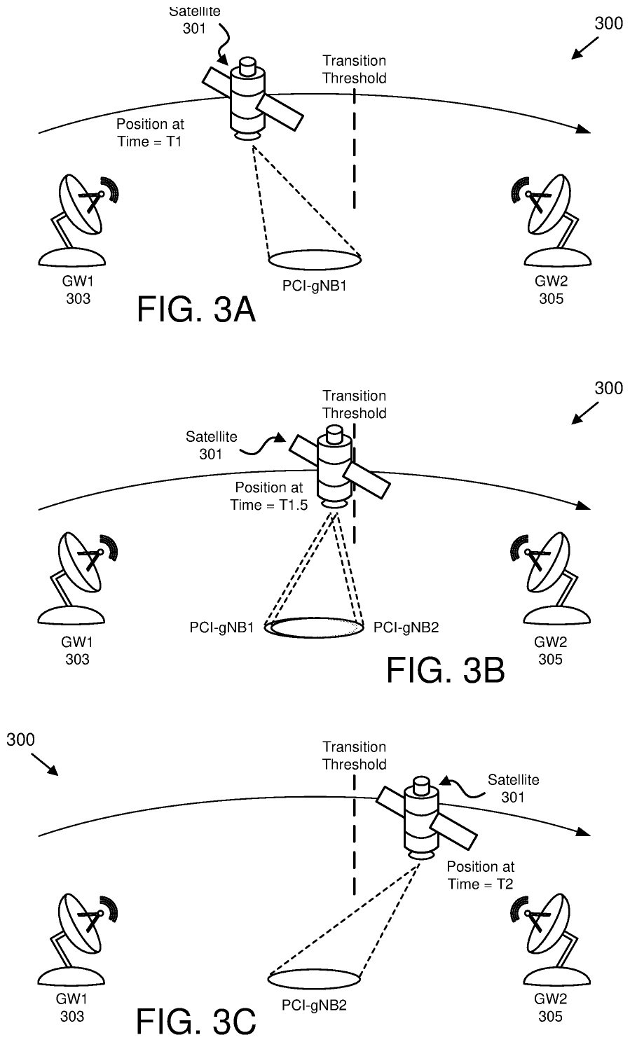

FIGS. 3A-3C depict an exemplary NTN 300 during feeder link switchover for a LEO transparent satellite 301 with two feeder links serving the satellite 301 during the switch. These Figures illustrate one possible solution to enable service continuity for feeder link switch. The NTN 300 includes the LEO transparent satellite 201, a first NTN-GW (denoted “GW1” 303), and a second NTN-GW (denoted “GW2” 305).

FIG. 3A depicts the NTN 300 at a moment in time (i.e., ‘T1’) prior to the feeder link switchover, according to embodiments of the disclosure. At the time ‘T1’, the satellite 301 has a first feeder link established with the first GW 303. At time ‘T1’, the satellite 301 is approaching the geographical location where the transition to be served by next GW will happen.

FIG. 3B depicts the NTN 300 at the transition time (denoted ‘T1.5’) when the feeder link switchover is performed and the satellite 301 is served by two GWs (i.e., GW1 303 and GW2 305).

FIG. 3C shows the NTN 300 at a moment in time (i.e., ‘T2’) after the transition to the second GW is finished, according to embodiments of the disclosure.

Assuming two feeder link connections serving via the same satellite 301 during the transition (e.g., at time T1.5 in FIG. 3B), there exists a Handover-based solution that should be feasible with Rel-15 or close to Rel-15 assumptions. This assumes that it is possible to represent cells of two different RAN nodes (i.e., gNBs) over a given area via the same satellite 301 but via different NTN-GWs. The two RAN nodes may utilize different radio resources of the transparent satellite (i.e., producing overlapping coverage areas) to ensure both RAN nodes are simultaneously visible to the UE.

During the feeder link switchover, the RAN node (e.g., gNB2) which serves the satellite 301 via GW2 305 may start transmitting the Cell-Defining Synchronization Signal Blocks (“CD-SSBs”) of its cells on synchronization raster points that are different from those of the RAN node (e.g., gNB1) which serves the satellite 301 via GW1 303. The UEs could have a handover from Physical Cell Identity (“PCI”) belonging to the gNB1 to PCI belonging to the gNB2. This could be a blind handover (i.e., network decision without measurement) or assisted with measurements.

Alternatively, the gNB1 may be present for a first time-period and configure a conditional handover to the gNB2, after which the gNB2 is available for a second time-period where the UEs can then perform the radio handover. Furthermore, the mobility solution may need to also mitigate for the fact that the UEs may observe very similar Reference Signal Received Power and/or Reference Signal Received Quality (“RSRP/RSRQ”) of the service links, provided by the source and target gNBs, because the reference signals are transmitted from the same satellite.

One solution may be left to network implementation, e.g., setting proper event A5 thresholds for conditional handover to enable handover, or to rely on radio propagation time instead or in combination with the RSRP/RSRQ radio measurements. Relying on radio propagation time includes to take the Round-Trip-Time (“RTT”) experienced by the UE into account in handover decisions, either as condition in conditional handover or in network handover decision.

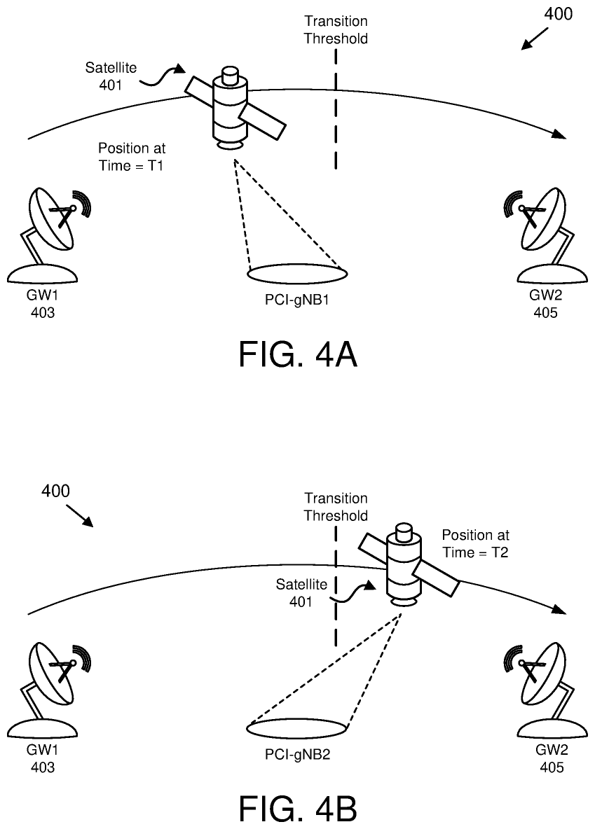

FIGS. 4A-4B depict an exemplary NTN 200 during feeder link switchover, according to another possible solution to enable service continuity for feeder link switch. The solution in FIG. 4A-4B depict feeder link switch over for LEO transparent satellite with one feeder links serving the satellite during the switch. The NTN 400 includes a satellite 401, a first NTN-GW (denoted “GW1” 403), and a second NTN-GW (denoted “GW2” 405).

FIG. 4A shows the NTN 400 at time 1 (‘T1’), where the satellite 401 stops transferring the signaling from the serving GW1 403 to the mobile communication network (i.e., RAN node 707 and/or 5GC 709).

FIG. 4B shows the NTN 400 at time 2 (TT), where the satellite 401 starts to transfer the signaling from the target GW2 405 to the mobile communication network (i.e., RAN node 707 and/or 5GC 709).

Assuming only one feeder link connection serving via the same satellite is applicable during the transition, which means the signal of the serving cell will be not available during time T1 to time T2 and a “hard” feeder link switchover is required. To allow the UE access to the serving cell again, two potential options are listed below:
Option 1: Feeder link hard switch procedure is based on accurate time control.

Assuming the old feeder link serves the satellite until to T1 and the new feeder link begins to serve the satellite from T2. This assumes that the cells of the source gNB(s) are represented over a given area at any time before T1, and the new cells of the target gNB(s) are represented from time T2.

As there is no overlap of source cells and target cells from the gNB(s) located at the old and the new NTN-GWs, the switch over relies on accurate time control. The handover command should be sent to all the UEs before T1, e.g., Conditional Handover. The UE should not initiate the handover procedure immediately upon receiving the Handover Command, instead, UE should initiate the handover procedure after T2, and thus an activation time should be included in the handover command to all the connected UEs.
Option 2: Feeder link hard switch procedure is based on conditional RRC re-establishment.

Considering the large cell size of NTN, it might be an extremely difficult problem for gNB1 to send handover commands to a large number of UEs respectively in a short time. A part of UEs may not be able to perform handover in time, as a result, radio link failure may be detected and then UEs initiate the RRC reestablishment procedure. It will take a long time to restore RRC connection, which may involve Radio Link Failure (“RLF”) detection, cell selection and potential reestablishment failure, as a result it has an influence on the service continuity. Thus, it may be beneficial for network to provide assistance information (e.g., next cell identity and/or reestablishment conditions) to trigger UE radio resource control (“RRC”) reestablishment instead. Besides, the assistance information can be sent to the UE via system information block (“SIB”) instead of dedicated signaling respectively, as a result, the signaling overhead caused by the large number of UEs can be effectively reduced.

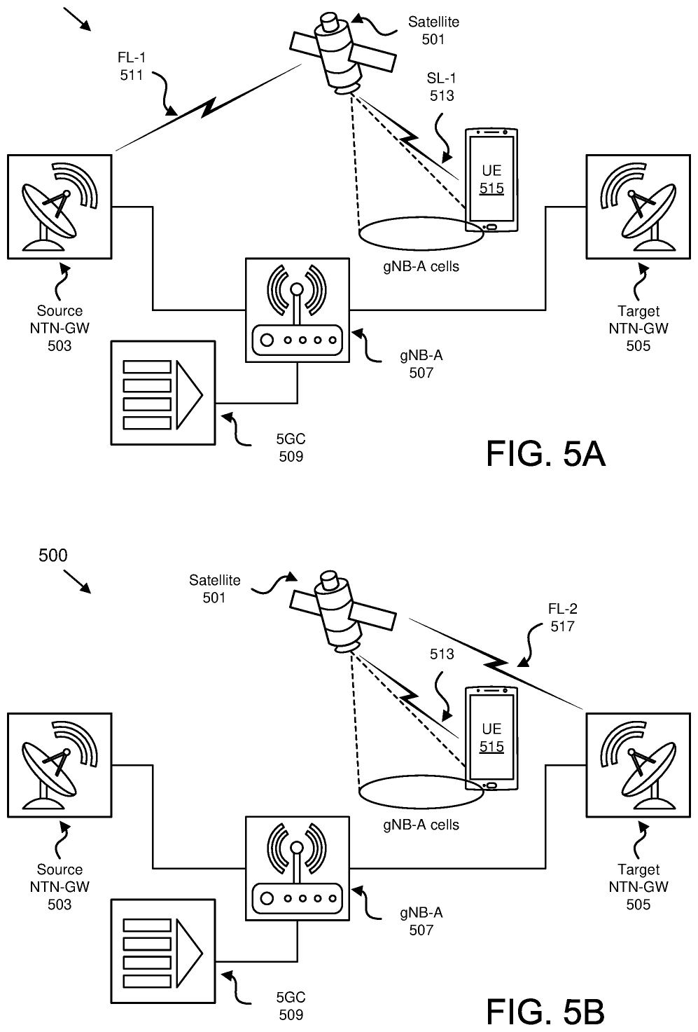

FIGS. 5A-5B depict a network architecture using a single gNB and two feeder links in a transparent satellite, according to embodiments of the disclosure. For situations where the transparent satellite is served before and after the feeder link switch by the same gNB, both feeder links are connected to the same gNB, but through different NTN-GWs. Assuming two feeder link connections serving via the same satellite during the transition, it could be possible for the gNB to keep the DL reference signals and to keep the cell “alive.”

Note: In this case, it may be possible to not to need a handover if the security keys of gNB can be kept but there may merely be an interruption, or slight discontinuity in DL transmissions. It should be also noted that the need for reconfiguration with synchronized handover (“sync(HO)”), or handover without synchronization, depends on whether gNB configuration remain the same or not during the switch.

Assuming only one feeder link connection serving via the same satellite during the transition, the satellite will need to first stop relaying using the feeder link connection with the NTN-GW1 and then start relaying using the target NTN-GW2. In this scenario the cell cannot be kept “alive” without interruption and there will be a discontinuity in DL transmissions as illustrated in FIGS. 5A-5B. For Feeder link hard switch, the solutions described above (for transparent satellite switchover to different gNBs) can be also applied to this same gNB scenario.

FIG. 5A depicts an NTN architecture 500 at a moment in time (i.e., ‘T1’) prior to the feeder link switchover, according to embodiments of the disclosure. The NTN 500 includes a transparent satellite 501, a source NTN-GW 503, a target NTN-GW 505, a RAN node 507 (depicted as “gNB A”), a core network 509, and a UE 515. At the time ‘T1’, the RAN node 507 is connected with the source NTN-GW 503 via a first feeder link (depicted “FL-1”) 511 and is serving the UE 515 via a service link (depicted “SL-1”) 513.

FIG. 5B depicts the NTN 200 at a moment in time (i.e., ‘T2’) after to the feeder link switchover, according to embodiments of the disclosure. At the time ‘T2’, the transparent satellite 501 has switched over to the target NTN-GW 505. At time T2, the RAN node 507 is connected with the target NTN-GW 505 via a second feeder link (depicted “FL-2”) 515 and uses the service link 513 to serve users (e.g., the UE 515) via the target NTN-GW 505.

The feeder link switchover relies on the temporary overlap of cells from the gNBs located at the old and the new NTN-GWs. The UEs are then handed over from the old to the new RAN node (gNB), before the old RAN node (gNB) detaches from the satellite. In certain embodiments, the new RAN node and the old RAN node are the same gNB, as depicted in FIGS. 5A-5B. In other embodiments, the new RAN node and the old RAN node may be different gNBs, e.g., as depicted in FIGS. 2A-2B.

For feeder link switchover, it is a prerequisite that the cells from the new RAN node are seen as neighbors by the old gNB, hence the Xn interface needs to be up and running between the two RAN nodes. As used herein, the term “Xn interface” refers to the interface between two base stations (e.g., two RAN nodes/gNBs). Furthermore, the whole process (from UEs measuring the new cells to handover completion) needs to take place before the old RAN node (gNB) detaches from the satellite (potentially critical for the LEO case).

It may be beneficial for the two RAN nodes to exchange information at Xn Setup and/or NG-RAN Node Configuration Update about the satellite(s) potentially involved, for example: A list of satellites to which the RAN node connects; B) For each satellite in the list, an identifier (“ID”), a list of cell(s) from the RAN node which is served through the satellite, and the ephemeris data for the satellite.

Described below are physical layer solutions for fast resynchronization in case of hard feeder link switch over for transparent satellites. This problem becomes critical as many UEs in an NTN cell start RACH procedure simultaneously after the feeder link switch. The RACH procedure is the procedure where the UE creates an initial connection with the network. A RACH occasion (“RO”) is an area specified in time and frequency domain that are available for the reception of RACH preamble. In 3GPP NR, the synchronization signal block (“SSB”) is associated with different beam. The UE selects a certain beam and sends a Physical Random Access Channel (“PRACH”) transmission using that beam. In order for the network to identify which beam the UE selected, a specific mapping is defined between SSB and RO. Thus, by detecting which RO the UE uses to send PRACH, the network can figure out which SSB/Beam that UE has selected.

However, due to limited number of preamble IDs in the current specification, i.e., 64, this will result in lot of collisions and signaling jam and hence leads to UE attachment delay due to multiple RACH attempts. In addition, there would be a transition period where feeder link switchover happens, that needs to be indicated to all UEs to avoid link failure. Moreover, in case of earth-moving cells, all UEs may not be affected due to feeder link switchover. Therefore, it may be desired to configure/assist only UEs that are affected due to handover.

The following solutions disclose signaling enhancements and procedures to remedy these issues, thereby achieving a reliable and fast connection after feeder link switchover.

In a first solution, the network transmits an indication of the satellite transition time. For earth-fixed cells, the indication may be sent semi-statically to a UE via dedicated RRC signaling or via Broadcast in a system information block (“SIB”). Alternatively, the indication may be sent dynamically via MAC CE, or DCI message, or some combination thereof. For earth-moving cells, the indication of the satellite transition time may be sent through SIB with location information. Alternatively, the indication may be sent using group-common DCI (“GC-DCI”) message.

In a second solution, the network transmits additional information that can assist in fast resynchronization, such as neighboring Cell-ID and next cell frequency (synchronization raster point), for earth-fixed cells and earth-moving cells. This additional information is also referred to herein as “resynchronization assistance information.” In certain embodiments, the resynchronization assistance information is indicated through dedicated RRC signaling, common RRC signaling, MAC CE, GC-DCI message, or some combination thereof.

In a third solution, the network implements group-based random-access procedure (“RACH procedure”) to avoid collisions after feeder link switchover. In certain embodiments, the RACH procedure is enhanced to avoid collisions by random UE grouping with random assignment of preambles and group ID. In certain embodiments, the RACH procedure is enhanced to avoid collisions by grouping UEs with assignment of ROs in a sequential manni. e.g., through a group-common DCI message. In certain embodiments, the RACH procedure is enhanced to avoid collisions by assigning UE-specific preamble ID with RO.

In a fourth solution, the network mitigates hard feeder link switchover by handing over a UE to a neighboring cell via another satellite link before the feeder link switchover starts to avoid link failure. In certain embodiments, as the UE approaches the start of satellite transition time (based on some threshold value), the UE can be handed over to a neighboring cell if the RSRP measurements from the neighboring cells is above certain threshold. In further embodiments, after the feeder link switchover is done, UE maybe handed over to the previous satellite link, if it provides better link quality. Otherwise, the UE may stay with the current link.

According to embodiments of the first solution, a transition period for feeder link switchover is indicated by a first NTN-GW and/or gNB (denoted “GW1/gNB1”) to all UEs or to a group of UEs that may be affected by switchover. Here, the transition period refers to the time when a satellite is performing feeder link switchover from the GW1/gNB1 to a second NTN-GW and/or gNB (denoted “GW2/gNB2”). The transition period indication may be configured to the UE(s) using higher layer signaling—such as dedicated RRC signaling or common RRC signaling or MAC/CE or DCI or any other signaling method. Upon receiving this signaling, the indicated UE(s) will pause their uplink communication for the defined period once they reach the transition period/time point signaled by the network. The UE(s) may also assume that there will be no downlink communication during this period. Note that the duration of transition period is defined based on the satellite altitude, speed, and feeder link switchover time.

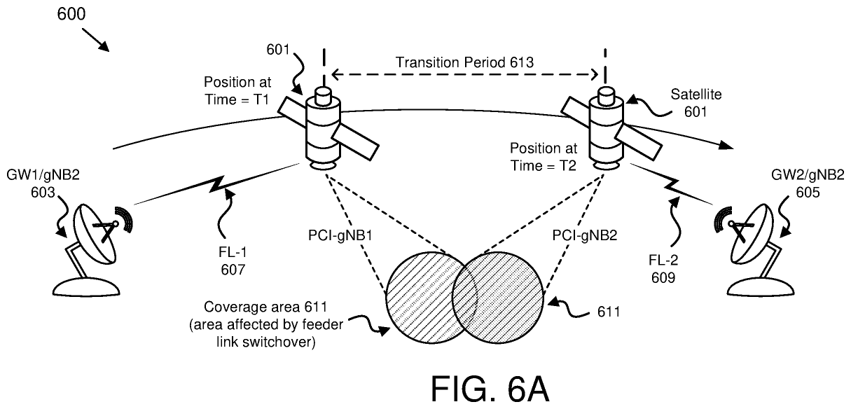

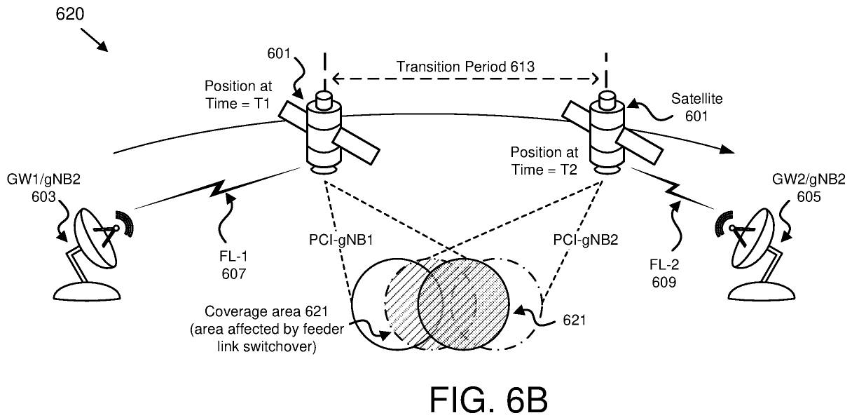

FIG. 6A depicts an exemplary procedure 600 for feeder link switchover for earth-fixed cells, according to embodiments of the first solution. The procedure 600 involves a satellite 601, a first NTN-GW and/or gNB (denoted “GW1/gNB1” 603), a second NTN-GW and/or gNB (denoted “GW2/gNB2” 605), and a coverage area 611 for feeder link switchover affected UEs. Prior to the transition period 613 (i.e., prior to feeder link switchover), the satellite 601 connects to the GW1/gNB1 603 using a first feeder link (denoted “FL-1”) 607. After the transition period 613 (i.e., after feeder link switchover completes), the satellite 601 connects to the GW1/gNB1 603 using a second feeder link (denoted “FL-2”) 609.

While connected to the GW1/gNB1 603, the satellite 601 provides earth-fixed cells with Physical Cell Identity (“PCI”) belonging to the gNB1. In the depicted embodiment, the satellite provides earth-fixed cells with PCI belonging to the gNB2 after feeder link switchover. Note that in other embodiments the NTN-GWs involved in switchover may connect to the same gNB, such that the earth-fixed cells provided by the satellite 601 have PCI belonging to the same gNB before and after the feeder link switchover.

FIG. 6B depicts an exemplary procedure 620 for feeder link switchover for earth-moving cells, according to embodiments of the first solution. The procedure 620 involves the satellite 601, the GW1/gNB1 603, the GW2/gNB2 605, and a coverage area 621 for feeder link switchover affected UEs. Prior to the transition period 613 (i.e., prior to feeder link switchover), the satellite 601 connects to the GW1/gNB1 603 using a first feeder link (denoted “FL-1”) 607. After the transition period 613 (i.e., after feeder link switchover completes), the satellite 601 connects to the GW1/gNB1 603 using a second feeder link (denoted “FL-2”) 609.

While connected to the GW1/gNB1 603, the satellite 601 provides earth-moving cells with Physical Cell Identity (“PCI”) belonging to the gNB1. In the depicted embodiment, the satellite provides earth-moving cells with PCI belonging to the gNB2 after feeder link switchover; however, in other embodiments the NTN-GWs involved in switchover may connect to the same gNB, such that the earth-moving cells provided by the satellite 601 have PCI belonging to the same gNB before and after the feeder link switchover.

In one embodiment of the first solution, the UEs will receive the transition period information through UE-specific RRC signaling or MAC CE during connection phase. Such implementation is useful if timing of feeder link switchover is exactly known or a maximum switchover time may be estimated. In one implementation of the first solution, the start and the duration of the transition period 613 is indicated in RRC signaling, where the starting time is UE-specific and is different for different UEs, depending upon the UE mobility and network connection.

In another implementation of the first solution, only duration of the transition period 613 is indicated in dedicated or common RRC signaling or MAC CE. In such case, the activation of the transition period 613 is configured by additional signaling such as a DCI message for earth-fixed cells. This activation may be based on a timer indicating a countdown, e.g., in terms of slots. The activation is broadcasted/configured to the affected UEs just before the start of transition period 613, e.g., before T1 in FIGS. 6A-6B. Such signaling may be more reliable as it is indicated to only those UEs that are affected due to feeder link switchover. In case of earth-moving cells, where this information is valid only for a group of UEs in a cell as indicated in FIG. 6B, a group-common DCI (“GC-DCI”) message may be utilized for activation.

In an alternate embodiment of the first solution, the start and duration of transition period 613 is indicated in a system information block (“SIB”). Such indication may be common to all UEs in the cell, all UEs served by a beam in the case of multi-beam cells, or a like. In the case of earth-moving cells, a location information may be included in SIB that indicates that SIB is valid for UEs in a certain geographical area (e.g., coverage area 611 or 621). For example, such location information may include inner and outer latitude and longitude axes of UEs to apply the timer. In this case, a UE located in the indicated range may run a switchover timer while a UE located outside the indicated range may neglect the procedure.

In another embodiment of the first solution, the start and duration of the transition period 613 is configured through a group-common DCI message. In the case of earth-fixed cells, the start and duration of the transition period 613 is configured for all UEs; however, in the case of earth-moving cells, the start and duration of the transition period 613 may be configured only for a set of UEs.

In each of the above embodiments, a granularity of the timer may be set according to subframe (1 ms) or half-subframe (0.5 ms) or slot duration. In the case of one or multiple slot or symbol duration, an associated subcarrier spacing (“SCS”) may be indicated explicitly or implicitly the latter for example by taking the active bandwidth part (“BWP”) default SCS as a default. When the timer is running, the UE decrements the timer according to the granularity of the timer.

In some embodiments of the first solution, rather than an exact time fora switchover timer, a minimum and maximum for the switchover time may be determined. Then, once the minimum switchover time has passed, the UE may attempt to detect a signal from the satellite 601 as an indication that it may initiate a RACH procedure. The maximum switchover time may then indicate the threshold after which the UE should attempt to reestablish a connection with the network.

In some embodiments of the first solution, a MAC CE or another higher layer message may trigger a switchover timer. A minimum and maximum switchover duration is helpful in these embodiments as well, as the timing may provide a coarser accuracy compared to a DCI message.

In some embodiments of the first solution, a minimum and maximum switchover time may be UE-specific, hence indicating to a UE or a group of UEs which ROs they may use for a RACH procedure. This will be explained with more details below in the descriptions of the third solution.

According to embodiments of the second solution, the essential information regarding the next cell, that may assist in fast resynchronization, is indicated by the serving cell, i.e., GW1/gNB1 before feeder link switchover happens. For example, this information may include next cell-ID and next cell frequency/synchronization raster point. If this information is known to a UE, the UE after the end of the transition period 613 (i.e., after time ‘T2’ in FIGS. 6A and 6B) will look for Synchronization Signal Block #1 (“SSB1”) on the already known frequency where it will need to perform a limited signal detection, e.g., detect only Primary Synchronization Signal (“PSS”) with known cell group N⁽²⁾_{ID} for time synchronization and frequency synchronization, the latter to find the offset of the Fast Fourier Transform (“FFT”) operation as a part of signal demodulation. In this example, the UE may discard Secondary Synchronization Signal (“SSS”) decoding as cell-ID is already known to the UE, hence N⁽¹⁾_{ID}, N⁽²⁾_{ID} may be obtained from the indicated cell-ID, thus resulting in faster synchronization.

For earth-fixed cells, where this information is valid for all UEs in a cell, this may be indicated through UE-dedicated RRC signaling, through common RRC configuration or through a broadcast signal. For earth-moving cells, this information may be indicated through group-common DCI or through SIB.

If indicated through SIB, a location information is also included in SIB, indicating the validity of SIB for UEs in a geographical area. However, all UEs in a cell may not have their precise location information or do not have the capability to know their location. In that case, indication through SIB may result in a false indication for some UEs.

In one implementation of the second solution, this information is configured in dedicated RRC signaling for all UEs in an earth-moving cell. However, such information will only be valid to the UEs if indicated by the gNB through another signaling method such as group-common DCI message. Therefore, a UE may determine that it should perform a resynchronization based on determining that it has received the next cell-ID information and also determining that it has received an associated signaling message, such as the group-common DCI message.

In one embodiment of the second solution, the Master Information Block (“MIB”) of next cell may be configured by the gNB1 through RRC signaling. In another implementation of the second solution, information such as SSB index, bandwidth part (“BWP”), and polarization of beam that will be covering to the UEs may also be indicated. Other MIB parameters of the next cell may also be signaled to the UE by the serving gNB, such as the Demodulation Reference Signal (“DMRS”) sequence for estimating the channel of PBCH in order to reduce the search for DMRS sequence that carries some MIB information.

In the above embodiments of the second solution, the MIB may be broadcast through a physical broadcast channel (“PBCH”) together with synchronization signals (PSS and SSS). If a UE has received the MIB in the next cell, that may allow the UE to perform a yet faster resynchronization as it may not need to decode the content of the MIB after detecting the associated PSS.

It may happen frequently that the assistance information provided to the UEs may not be reliable. This may be due to the location of UEs (UEs at cell edges), or due to the UE mobility/channel related issues or due to satellite feeder link switching time errors. In such case, even with the resynchronization assistance information, hard feeder link switchover may result in a link failure for multiple UEs, thus RRC reestablishment. Therefore, in one embodiment of the second solution, UEs may be configured with secondary information such as a sequential list of cell-IDs and the corresponding synchronization raster points. This information may additionally be indicated to all UEs through a SIB. In one implementation of the second solution, to avoid the signaling overhead, this information may only be indicated to a set of vulnerable UEs through a group-common DCI or UE-specific signaling.

In some realizations, a UE may be provided maximum and minimum switchover time, hence attempting a reconnection after the minimum switchover has passed. Reattempting may continue until the timer reaches the maximum switchover time as indicated to the UE, in which case, if reconnection is not successful, the UE may attempt to connect to another base station (terrestrial or non-terrestrial) rather than attempting to reconnect as indicated by the network.

According to embodiments of the third solution, UEs are grouped in a way that number of UEs attempting for RACH procedure do not exceed a certain threshold, for example the number of preambles, i.e., 64 for a RACH occasion (“RO”). In NTN, the cell size is large as compared to the terrestrial network. Consequently, the number of users is also large especially in a case where multiple beams are supported in a cell. After the feeder link switchover, all UEs will randomly choose a preamble and send Msg1 according to the current state of the art. This will cause multiple collisions at gNB, resulting in link failure.

In one embodiment of the third solution, UEs are grouped in a random manner where each group may be assigned with different ROs, e.g., by indicating a time offset. Based on the number of UEs in a cell, an index indicating the maximum number of groups and timing offset for RO(s) is transmitted through DCI or broadcasted through SIB via the serving gNB before the switchover. For example, in an earth-fixed cell with 350 UEs, a group number of 6 will be broadcasted or 6 groups number with ROs offset. During RACH attempts to the gNB2 and after the synchronization to the gNB2 is done, a UE may first select a random group number, e.g., one number in between 1 to 6, and then a random preamble and uses ROs for preamble transmission assigned to its selected group. Such sort of grouping and indication result in fairness among users and low signaling latency.

In another embodiment of the third solution, UEs are grouped randomly or according to one or multiple criteria, e.g., grouping based on UE location for earth-moving cells or grouping based on some criteria. Each group may be configured with ROs for the next serving cell through a group-common DCI or UE-specific signaling. In one implementation of the third solution, UEs in a group choose a random preamble and only have the information of group number and its association with an RO.

In another implementation of the third solution, each UE is assigned by the gNB before feeder link switchover (e.g., gNB1 in FIGS. 6A and 6B), with a preamble and RO for the next serving cell, similar to the contention-free RACH procedure. Then, after the feeder link switchover has completed, each UE uses the configured preamble ID and the corresponding RO(s) without random selection. In such embodiments, this preamble and RO assignment information may either be dynamically indicated prior to the switchover (e.g., through a new field in DCI 1_1 or with a new DCI format) or configured through dedicated RRC signaling.

In case of RRC signaling, this assignment may not be valid for some UEs at the time of feeder link switchover, e.g., due to UE mobility or satellite mobility especially for earth-moving cells. Therefore, if configured through dedicated RRC, the UEs may additionally be signaled through group-common DCI with a single bit just before T1 (as indicated in FIGS. 6A and 6B) to indicate its validity. Other RRC RACH related parameters can also be signaled beforehand to the affected UEs. For example, the PreambleInitialReceivedTargetPower and the powerRampingStep for transmitting PRACH may be jointly configured to the UEs or to each UE separately based on its location since the path loss to the satellite at the switchover time point can be estimated. This information that usually signaled through common RRC configuration can be signaled to the UEs through DCI from the serving gNB1.

In one embodiment of the third solution, the number of PRACH transmission occasions frequency division multiplexed in one-time instance are increased from 8 to “N” number according to BWP of next cell taking into account the selected preamble format. In one implementation of the third solution, the number of preamble sequences are increased (a new preamble format is used with larger length that result in more possible orthogonal sequences) for NTN to accommodate more users. This will also help in reducing the latency thanks to the less collisions and hence less RACH attempts for each user.

In one embodiment of the third solution, UEs may be assigned to use two or more preamble IDs with different time offset. In case of no Msg 2 reception, UE will assume that there is a collision at gNB and instead of RRC reestablishment, UE will use another assigned preamble with the indicated offset without random selection of both preambles. In one implementation of this embodiment, a first number of attempts may be associated with the first preamble ID. In this case the UE may attempt a RACH with the first preamble ID by the associated number of times before attempting with a second preamble ID. This realization may be extended to a larger number of preamble IDs.

As proposed for the first solution, a minimum and maximum switchover time may be UE-specific, hence indicating to a UE or a group of UEs which ROs they may use for a RACH procedure. In some embodiments of the third solution, a minimum from the starting event of the switchover time (for example a signaling to start a timer) may be the starting time to perform a RACH procedure as configured and signaling by the network, e.g., a contention-free RACH procedure with indicated one or multiple preamble IDs. Then a maximum value may indicate to the UE when to finish performing the limited RACH procedure and switch to a full procedure (such as a contention-based procedure with a random preamble ID) for establishing a new connection.

In some implementations of the third solution, UEs are grouped implicitly based on indicated minimum and maximum values for a timer. In other implementations of the third solution, timer values of UEs may be partially overlapping, hence attempting to distribute the reconnection signaling load among multiple ROs without grouping the UEs into nonoverlapping groups. More vulnerable UEs may be provided a smaller minimum value and a larger maximum value such that they may start a RACH procedure faster and be able to attempt for a more extended period of time.

According to embodiments of the fourth solution, when the transition time is ‘t’ time units away (i.e., ‘t’ units before the start of feed link switch-over), then the handover procedure is initiated for a UE or a group of UEs with another satellite link to avoid any downtime for UL/DL transmissions. The said procedure may be initiated to a same link or to a different link. The selection of link may be based on link measurements from a set of neighboring cells, and if at least one the measured neighboring cells have Reference Signal Received Power (“RSRP”) above a certain threshold, then the handover can be performed. In some embodiments of the fourth solution, if multiple cells have RSRP values above the threshold, a cell with the highest RSRP or a longer expected dwelling time (based on satellite path projection and UE location, for example) may be selected. The threshold may be configured semi-statically, or a threshold based on an offset with an RSRP from the current cell may be considered.

In some embodiments of the fourth solution, the different link may be network planned based on satellite path projection, UE location and/or path projection, and so on. In one implementation of the fourth solution, the handover can be initiated based on a set of configurations already indicated to the UE such as transition time for a satellite, threshold time unit ‘t’ before the start of transition time when the autonomous handover can be performed, neighboring cell IDs, threshold cell RSRP measurements to allow handover, synchronization raster, and/or initial BWP.

In some embodiments of the fourth solution, after the feeder link switchover is complete for the first satellite link, the UE can be configured to autonomously handover to the previous link if possible, for example if the required link quality is still above a threshold or an expected dwelling time is above a threshold. The UE may be indicated with the transition time and other related parameters and, hence, it will know whether and when to initiate the handover back to first satellite link.

In alternative embodiments of the fourth solution, a UE is not expected to autonomously switch back to the link with the first satellite automatically, i.e., the current satellite link is considered the primary link. Nevertheless, the UE may follow a similar procedure as it performed with the first satellite link for another feeder link switchover.

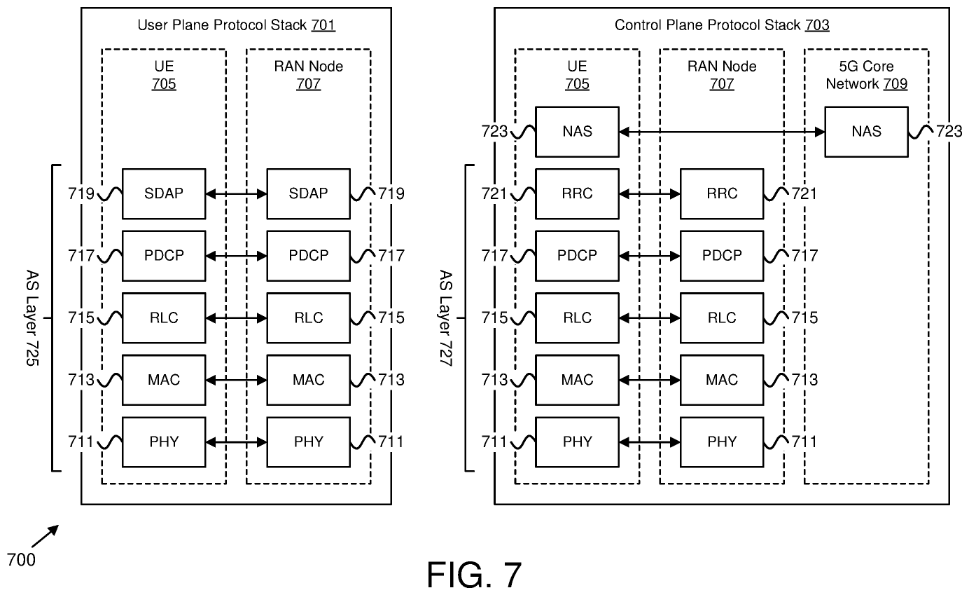

FIG. 7 depicts a NR protocol stack 700, according to embodiments of the disclosure. While FIG. 7 shows a UE 705, a RAN node 707 and the 5G core network 709, these are representative of a set of remote units 105 interacting with a base unit 121 and a mobile core network 140. As depicted, the NR protocol stack 700 comprises a User Plane protocol stack 701 and a Control Plane protocol stack 703. The User Plane protocol stack 701 includes a physical (“PHY”) layer 711, a Medium Access Control (“MAC”) sublayer 713, a Radio Link Control (“RLC”) sublayer 715, a Packet Data Convergence Protocol (“PDCP”) sublayer 717, and Service Data Adaptation Protocol (“SDAP”) layer 719. The Control Plane protocol stack 703 includes a PHY layer 711, a MAC sublayer 713, a RLC sublayer 715, and a PDCP sublayer 717. The Control Plane protocol stack 703 also includes a Radio Resource Control (“RRC”) layer 721 and a Non-Access Stratum (“NAS”) layer 723.

Note that with transparent satellite architectures, the satellite acts as a repeater, but does not terminate the NR-Uu interface. In some embodiments, the NTN may relay signaling for one or more layers between the UE 705 and the RAN node 707, according to the arrangement shown in FIG. 1. Alternatively, the NTN may relay NAS layer signaling between the RAN node 707 and the 5GC 709 (note that NAS singling is transparent to the RAN node 707).

The AS layer 725 (also referred to as “AS protocol stack”) for the User Plane protocol stack 701 consists of at least SDAP, PDCP, RLC and MAC sublayers, and the PHY layer. The AS layer 727 for the Control Plane protocol stack 703 consists of at least RRC, PDCP, RLC and MAC sublayers, and the PHY layer. The Layer-2 (“L2”) is split into the SDAP, PDCP, RLC and MAC sublayers. The Layer-3 (“L3”) includes the RRC sublayer 721 and the NAS layer 723 for the control plane and includes, e.g., an Internet Protocol (“IP”) layer or PDU Layer (note depicted) for the user plane. L1 and L2 are referred to as “lower layers,” while L3 and above (e.g., transport layer, application layer) are referred to as “higher layers” or “upper layers.”

The PHY layer 711 offers transport channels to the MAC sublayer 713. The MAC sublayer 713 offers logical channels to the RLC sublayer 715. The RLC sublayer 715 offers RLC channels to the PDCP sublayer 717. The PDCP sublayer 717 offers radio bearers to the SDAP sublayer 719 and/or RRC layer 721. The SDAP sublayer 719 offers QoS flows to the core network (e.g., 5GC 709). The RRC layer 721 provides for the addition, modification, and release of Carrier Aggregation (“CA”) and/or Dual Connectivity (“DC”). The RRC layer 721 also manages the establishment, configuration, maintenance, and release of Signaling Radio Bearers (“SRBs”) and Data Radio Bearers (“DRBs”).

The MAC layer 713 is the lowest sublayer in the Layer-2 architecture of the NR protocol stack. Its connection to the PHY layer 711 below is through transport channels, and the connection to the RLC layer 715 above is through logical channels. The MAC layer 713 therefore performs multiplexing and demultiplexing between logical channels and transport channels: the MAC layer 713 in the transmitting side constructs MAC PDUs, known as transport blocks, from MAC Service Data Units (“SDUs”) received through logical channels, and the MAC layer 713 in the receiving side recovers MAC SDUs from MAC PDUs received through transport channels.

The MAC layer 713 provides a data transfer service for the RLC layer 715 through logical channels, which are either control logical channels which carry control data (e.g., RRC signaling) or traffic logical channels which carry user plane data. On the other hand, the data from the MAC layer 713 is exchanged with the PHY layer 711 through transport channels, which are classified as downlink or uplink. Data is multiplexed into transport channels depending on how it is transmitted over the air.

The PHY layer 711 is responsible for the actual transmission of data and control information via the air interface, i.e., the PHY layer 711 carries all information from the MAC transport channels over the air interface on the transmission side. Some of the important functions performed by the PHY layer 711 include coding and modulation, link adaptation (e.g., Adaptive Modulation and Coding (“AMC”)), power control, cell search (for initial synchronization and handover purposes) and other measurements (inside the 3GPP system (i.e., NR and/or LTE system) and between systems) for the RRC layer 721. The PHY layer 711 performs transmissions based on transmission parameters, such as the modulation scheme, the coding rate (i.e., the modulation and coding scheme (“MCS”)), the number of physical resource blocks etc.

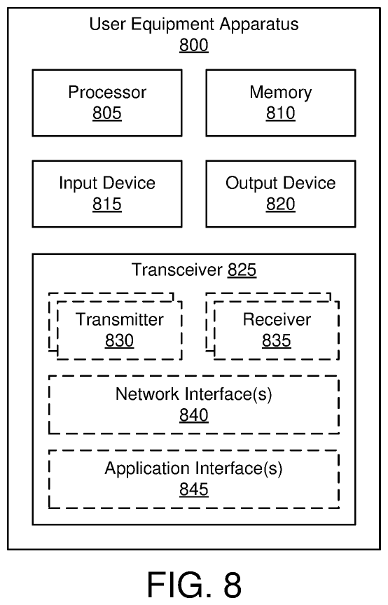

FIG. 8 depicts a user equipment apparatus 800 that may be used for handling satellite hard feeder link switchover, according to embodiments of the disclosure. In various embodiments, the user equipment apparatus 800 is used to implement one or more of the solutions described above. The user equipment apparatus 800 may be one embodiment of the remote unit 105, the UE 515, and/or the UE 705, described above. Furthermore, the user equipment apparatus 800 may include a processor 805, a memory 810, an input device 815, an output device 820, and a transceiver 825.

In some embodiments, the input device 815 and the output device 820 are combined into a single device, such as a touchscreen. In certain embodiments, the user equipment apparatus 800 may not include any input device 815 and/or output device 820. In various embodiments, the user equipment apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. In some embodiments, the transceiver 825 communicates with one or more cells (or wireless coverage areas) supported by one or more base units 121. In various embodiments, the transceiver 825 is operable on unlicensed spectrum. Moreover, the transceiver 825 may include multiple UE panels supporting one or more beams. Additionally, the transceiver 825 may support at least one network interface 840 and/or application interface 845. The application interface(s) 845 may support one or more APIs. The network interface(s) 840 may support 3GPP reference points, such as Uu, N1, PC5, etc. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the processor 805 controls the user equipment apparatus 800 to implement the above described UE behaviors. In certain embodiments, the processor 805 may include an application processor (also known as “main processor”) which manages application-domain and operating system (“OS”) functions and a baseband processor (also known as “baseband radio processor”) which manages radio functions.

In various embodiments, the processor 805 receives a configuration via the transceiver 825, where the configuration indicates a transition period required by a satellite connected to a first NTN gateway for feeder link switchover to a second NTN gateway, the transition period defined by a transition time and a transition duration. The term “transition time” is used to indicate the beginning of the transition period, i.e., when the switchover will take place, while the term “transition duration” is used to indicate the length of the transition period. The processor 805 suspends communication with the mobile communication network at the transition time (i.e., by pausing uplink and assuming there will be no downlink) and resumes communication with the mobile communication network after expiry of the transition duration.

In some embodiments, receiving the configuration includes receiving the transition duration via higher layer signaling (e.g., RRC signaling and/or MAC CE). In such embodiments, the transceiver 825 further receives DCI that indicates the transition time, where a type of DCI received (i.e., whether UE-specific or group-common) is based at least in part on a type of cell (i.e., earth-fixed cell or earth-moving cell) serving the UE.

In some embodiments, receiving the configuration includes receiving the transition duration and the transition time via group-common downlink control information. In some embodiments, resuming communication with the mobile communication network includes performing a RACH procedure. In such embodiments, the transceiver 825 further receives a second configuration from the network, where the second configuration contains at least one of: A) resynchronization assistance information indicating at least one neighboring cell having a link to the second gateway; and B) a post-switchover RACH occasion.

In certain embodiments, the resynchronization assistance information comprises a set of cell identities for the at least one neighboring cell and a corresponding synchronization raster point (i.e., cell frequency of the neighboring cell) for each cell identity. In such embodiments, receiving the resynchronization assistance information may include receiving via one of: dedicated RRC signaling, common RRC signaling, MAC CE, broadcast signal, GC-DCI, or some combination thereof. In certain embodiments, the resynchronization assistance information further includes location information indicating a geographical area where the resynchronization assistance information is valid.

In certain embodiments, the second configuration further indicates a set of candidate RACH groups, each RACH group assigned with a different post-switchover RACH occasion. In such embodiments, the processor 805 may further select a candidate RACH group in a random manner and performing random access procedure at a post-switchover RACH occasion corresponding to the selected RACH group. In certain embodiments, the second configuration further indicates a RACH preamble to at the post-switchover RACH occasion.

In various embodiments, the processor 805 receives a configuration via the transceiver 825, where the configuration indicates a transition period required by a satellite connected to a first NTN gateway for feeder link switchover to a second NTN gateway, the transition period defined by a transition time and a transition duration. The transceiver 825 further receives a second configuration from the network, where the second configuration contains a threshold time before the transition time (i.e., before the start of feeder link switchover). The processor 805 initiates a handover procedure to a new cell when the threshold time before the transition time is reached, where the new cell is not associated with the first satellite. In some embodiments, initiating the handover procedure includes selecting the new cell based on link measurements from a set of neighboring cells and expected beam dwelling time for the set of neighboring cells.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to BWP and beam switching. For example, the memory 810 may store various parameters, panel/beam configurations, resource assignments, policies, and the like as described above. In certain embodiments, the memory 810 also stores program code and related data, such as an operating system or other controller algorithms operating on the apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 820 may include a wearable display separate from, but communicatively coupled to, the rest of the user equipment apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 communicates with one or more network functions of a mobile communication network via one or more access networks. The transceiver 825 operates under the control of the processor 805 to transmit messages, data, and other signals and also to receive messages, data, and other signals. For example, the processor 805 may selectively activate the transceiver 825 (or portions thereof) at particular times in order to send and receive messages.

The transceiver 825 includes at least transmitter 830 and at least one receiver 835. One or more transmitters 830 may be used to provide UL communication signals to a base unit 121, such as the UL transmissions described herein. Similarly, one or more receivers 835 may be used to receive DL communication signals from the base unit 121, as described herein. Although only one transmitter 830 and one receiver 835 are illustrated, the user equipment apparatus 800 may have any suitable number of transmitters 830 and receivers 835. Further, the transmitter(s) 830 and the receiver(s) 835 may be any suitable type of transmitters and receivers. In one embodiment, the transceiver 825 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 825, transmitters 830, and receivers 835 may be implemented as physically separate components that access a shared hardware resource and/or software resource, such as for example, the network interface 840.

In various embodiments, one or more transmitters 830 and/or one or more receivers 835 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 830 and/or one or more receivers 835 may be implemented and/or integrated into a multi-chip module. In some embodiments, other components such as the network interface 840 or other hardware components/circuits may be integrated with any number of transmitters 830 and/or receivers 835 into a single chip. In such embodiment, the transmitters 830 and receivers 835 may be logically configured as a transceiver 825 that uses one more common control signals or as modular transmitters 830 and receivers 835 implemented in the same hardware chip or in a multi-chip module.

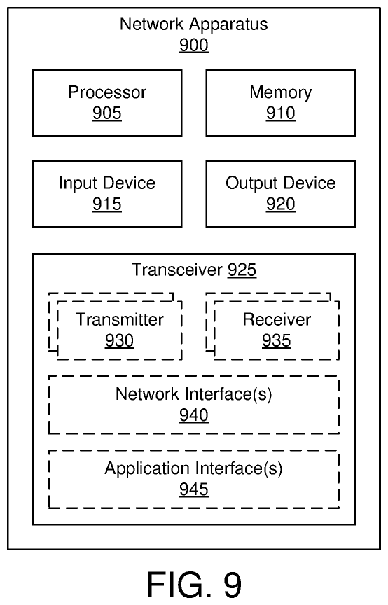

FIG. 9 depicts a network apparatus 900 that may be used for handling satellite hard feeder link switchover, according to embodiments of the disclosure. In one embodiment, network apparatus 900 may be one implementation of a RAN device, such as the base unit 121, as described above. Furthermore, the network apparatus 900 may include a processor 905, a memory 910, an input device 915, an output device 920, and a transceiver 925.

In some embodiments, the input device 915 and the output device 920 are combined into a single device, such as a touchscreen. In certain embodiments, the network apparatus 900 may not include any input device 915 and/or output device 920. In various embodiments, the network apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. Here, the transceiver 925 communicates with one or more remote units 105. Additionally, the transceiver 925 may support at least one network interface 940 and/or application interface 945. The application interface(s) 945 may support one or more APIs. The network interface(s) 940 may support 3GPP reference points, such as Uu, N1, N2 and N3. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a CPU, a GPU, an auxiliary processing unit, a FPGA, or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the network apparatus 900 is a RAN node (e.g., gNB) that communicates with one or more UEs, as described herein. In such embodiments, the processor 905 controls the network apparatus 900 to perform the above described RAN behaviors. When operating as a RAN node, the processor 905 may include an application processor (also known as “main processor”) which manages application-domain and operating system (“OS”) functions and a baseband processor (also known as “baseband radio processor”) which manages radio functions.

In various embodiments, the processor 905 creates a configuration indicating a transition period required by a satellite connected to a first NTN gateway for feeder link switchover to a second NTN gateway, the transition period defined by a transition time and a transition duration. The transceiver 925 sends the configuration to at least one UE. The processor 905 suspends communication with the at least one UE at the transition time (i.e., by pausing downlink and assuming there will be no uplink) and resumes communication with the at least one UE after expiry of the transition duration.

In some embodiments, the transition period is indicated by a current serving RAN node (i.e., gNB) to a group of UEs that are affected by switchover. In such embodiments, transmitting the first configuration includes sending the transition time and transition duration via one or more of: dedicated RRC signaling, common RRC signaling, MAC CE, broadcast signal, GC-DCI, or some combination thereof.

In some embodiments, the transition time is UE specific and is different for different UEs in the first cell. In such embodiments, the processor 905 further determines a UE-specific transition time for a particular UE based upon mobility of the particular UE and a network connection of the particular UE.

In some embodiments, the transceiver 925 further transmits a second configuration to the at least one UE, where the second configuration contains at least one of: A) resynchronization assistance information indicating at least one neighboring cell having a link to the second gateway; B) a post-switchover RACH occasion. In certain embodiments, the processor 905 further groups UEs in the first cell, where the RACH occasion is for a group of UEs and where the groups are selected to ensure that a number of UEs attempting for RACH procedure does not exceed a certain threshold.

In various embodiments, the processor 905 creates a first configuration and a second configuration. The first configuration indicates a transition period required by a satellite connected to a first NTN gateway for feeder link switchover to a second NTN gateway, the transition period defined by a transition time and a transition duration. The second configuration contains a threshold time before the transition time (i.e., before the start of feeder link switchover). The transceiver 925 sends the first configuration and the second configuration to at least one UE.

The processor 905 initiates a procedure to handover the at least one UE to a new cell when the threshold time before the transition time is reached, where the new cell is not associated with the first satellite. In some embodiments, initiating the handover procedure includes selecting the new cell based on link measurements from a set of neighboring cells and expected beam dwelling time for the set of neighboring cells.

The memory 910, in one embodiment, is a computer readable storage medium. In some embodiments, the memory 910 includes volatile computer storage media. For example, the memory 910 may include a RAM, including dynamic RAM (“DRAM”), synchronous dynamic RAM (“SDRAM”), and/or static RAM (“SRAM”). In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to BWP and beam switching. For example, the memory 910 may store parameters, configurations, resource assignments, policies, and the like, as described above. In certain embodiments, the memory 910 also stores program code and related data, such as an operating system or other controller algorithms operating on the apparatus 900.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, an LCD display, an LED display, an OLED display, a projector, or similar display device capable of outputting images, text, or the like to a user. As another, non-limiting, example, the output device 920 may include a wearable display separate from, but communicatively coupled to, the rest of the network apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, the output device 920 may be located near the input device 915.

The transceiver 925 includes at least transmitter 930 and at least one receiver 935. One or more transmitters 930 may be used to communicate with the UE, as described herein. Similarly, one or more receivers 935 may be used to communicate with network functions in the Public Land Mobile Network (“PLMN”) and/or RAN, as described herein. Although only one transmitter 930 and one receiver 935 are illustrated, the network apparatus 900 may have any suitable number of transmitters 930 and receivers 935. Further, the transmitter(s) 930 and the receiver(s) 935 may be any suitable type of transmitters and receivers.

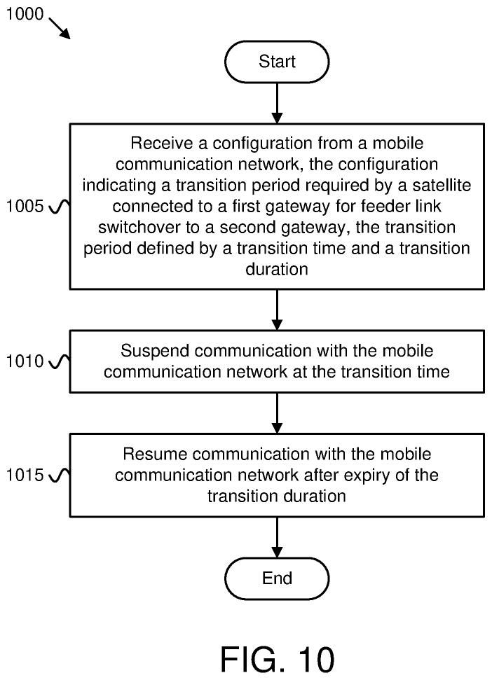

FIG. 10 depicts one embodiment of a method 1000 for handling satellite hard feeder link switchover, according to embodiments of the disclosure. In various embodiments, the method 1000 is performed by a UE device, such as the remote unit 105, the UE 515, the UE 705, and/or the user equipment apparatus 800, described above as described above. In some embodiments, the method 1000 is performed by a processor, such as a microcontroller, a microprocessor, a CPU, a GPU, an auxiliary processing unit, a FPGA, or the like.

The method 1000 begins and receives 1005 a configuration from a mobile communication network, the configuration indicating a transition period required by a satellite connected to a first gateway for feeder link switchover to a second gateway, the transition period defined by a transition time and a transition duration. The method 1000 includes suspending 1010 communication with the mobile communication network at the transition time (i.e., pausing uplink and assuming there will be no downlink). The method 1000 includes resuming 1015 communication with the mobile communication network after expiry of the transition duration. The method 1000 ends.

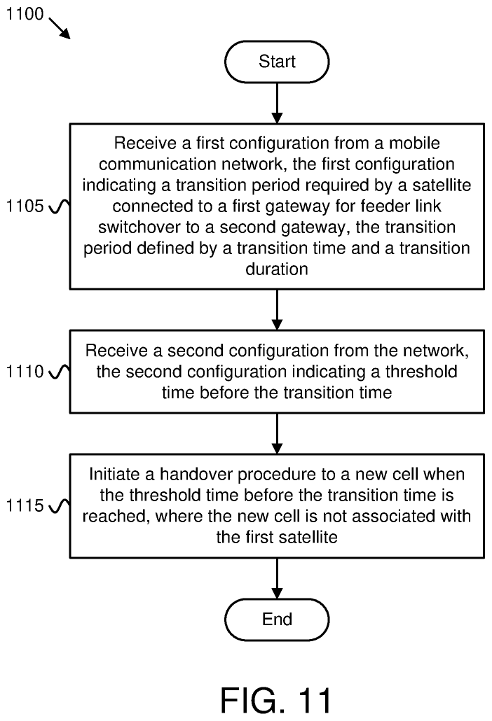

FIG. 11 depicts one embodiment of a method 1100 for handling satellite hard feeder link switchover, according to embodiments of the disclosure. In various embodiments, the method 1100 is performed by a UE device, such as the remote unit 105, the UE 515, the UE 705, and/or the user equipment apparatus 800, described above as described above. In some embodiments, the method 1100 is performed by a processor, such as a microcontroller, a microprocessor, a CPU, a GPU, an auxiliary processing unit, a FPGA, or the like.

The method 1100 begins and receives 1105 a first configuration from a mobile communication network, the first configuration indicating a transition period required by a satellite connected to a first gateway for feeder link switchover to a second gateway, the transition period defined by a transition time and a transition duration. The method 1100 includes receiving 1110 a second configuration from the network, the second configuration indicating a threshold time before the transition time (i.e., before the start of feeder link switchover) and initiating 1115 a handover procedure to a new cell when the threshold time before the transition time is reached, where the new cell is not associated with the first satellite. The method 1100 ends.

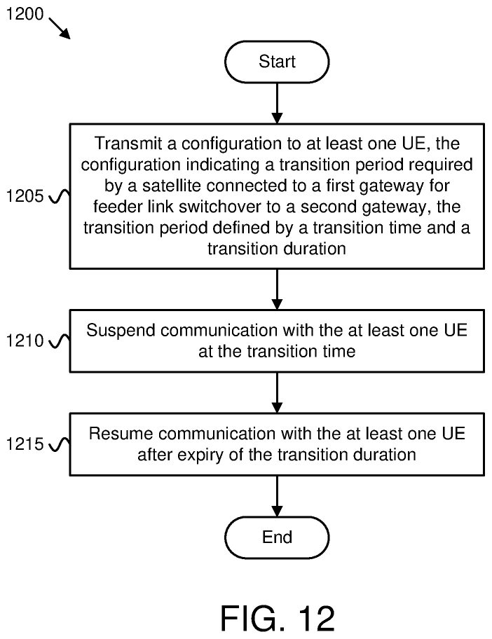

FIG. 12 depicts one embodiment of a method 1200 for handling satellite hard feeder link switchover, according to embodiments of the disclosure. In various embodiments, the method 1200 is performed by a network entity, such as the base unit 121, the NTN gateway 123, the satellite 130, the satellite 201, the GW1 203, the GW2 205, the satellite 301, the GW1 303, the GW2 305, the satellite 401, the GW1 403, the GW2 405, the satellite 501, the source NTN-GW 503, the target NTN-GW 505, the RAN node 507 (gNB-A), the satellite 601, the GW1/gNB1 603, the GW2/gNB2 605, the RAN node 707, and/or the network apparatus 900, described above as described above. In some embodiments, the method 1200 is performed by a processor, such as a microcontroller, a microprocessor, a CPU, a GPU, an auxiliary processing unit, a FPGA, or the like.

The method 1200 begins and transmits 1205 a configuration to at least one UE, the configuration indicating a transition period required by the satellite connected to the first gateway for feeder link switchover to the second gateway, the transition period defined by a transition time and a transition duration. The method 1200 includes suspending 1210 communication with the at least one UE at the transition time (i.e., by pausing downlink and assuming there will be no uplink). The method 1200 includes resuming 1215 communication with the at least one UE after expiry of the transition duration. The method 1200 ends.

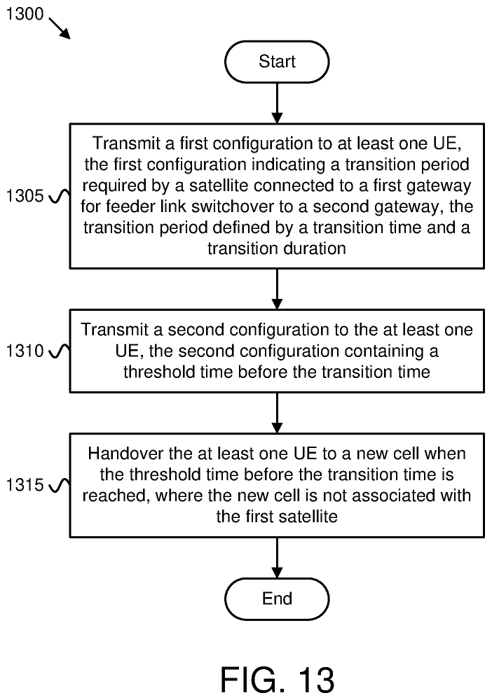

FIG. 13 depicts one embodiment of a method 1300 for handling satellite hard feeder link switchover, according to embodiments of the disclosure. In various embodiments, the method 1300 is performed by a network entity, such as the base unit 121, the NTN gateway 123, the satellite 130, the satellite 201, the GW1 203, the GW2 205, the satellite 301, the GW1 303, the GW2 305, the satellite 401, the GW1 403, the GW2 405, the satellite 501, the source NTN-GW 503, the target NTN-GW 505, the RAN node 507 (gNB-A), the satellite 601, the GW1/gNB1 603, the GW2/gNB2 605, the RAN node 707, and/or the network apparatus 900, described above as described above. In some embodiments, the method 1300 is performed by a processor, such as a microcontroller, a microprocessor, a CPU, a GPU, an auxiliary processing unit, a FPGA, or the like.

The method 1300 begins and transmits 1305 a first configuration to at least one UE, the configuration indicating a transition period required by a satellite connected to a first gateway for feeder link switchover to a second gateway, the transition period defined by a transition time and a transition duration. The method 1300 includes transmitting 1310 a second configuration to the at least one UE, the second configuration containing a threshold time before the transition time (i.e., before the start of feeder link switchover). The method 1300 includes handing over 1315 the at least one UE to a new cell when the threshold time before the transition time is reached, where the new cell is not associated with the first satellite. The method 1300 ends.

Disclosed herein is a first apparatus for handling satellite hard feeder link switchover, according to embodiments of the disclosure. The first apparatus may be implemented by a UE device, such as the remote unit 105, the UE 515, the UE 705, and/or the user equipment apparatus 800, described above. The first apparatus includes a processor that and a transceiver receiving a first configuration from a mobile communication network, where the network comprises a satellite, a first gateway (e.g., gNB) to which the satellite is connected, and a second gateway (e.g., gNB) to which the satellite is to connect in the future. Here, the first configuration indicates a transition period required by the satellite connected to the first gateway for feeder link switchover to the second gateway, the transition period defined by a transition time and a transition duration. The processor suspends communication with the mobile communication network at the transition time (i.e., by pausing uplink and assuming there will be no downlink) and resumes communication with the mobile communication network after expiry of the transition duration.

In some embodiments, receiving the first configuration includes receiving the transition duration via higher layer signaling (e.g., RRC signaling and/or MAC CE). In such embodiments, the transceiver further receives DCI that indicates the transition time, where a type of DCI received (i.e., whether UE-specific or group-common) is based at least in part on a type of cell (i.e., earth-fixed cell or earth-moving cell) serving the UE.

In some embodiments, receiving the first configuration includes receiving the transition duration and the transition time via group-common downlink control information. In some embodiments, resuming communication with the mobile communication network includes performing a RACH procedure. In such embodiments, the transceiver further receives a second configuration from the network, said second configuration containing at least one of: A) resynchronization assistance information indicating at least one neighboring cell having a link to the second gateway; and B) a post-switchover RACH occasion.

In certain embodiments, the resynchronization assistance information comprises a set of cell identities for the at least one neighboring cell and a corresponding synchronization raster point (i.e., cell frequency of the neighboring cell) for each cell identity. In such embodiments, receiving the resynchronization assistance information may include receiving via one of: dedicated RRC signaling, common RRC signaling, MAC CE, broadcast signal, GC-DCI, or some combination thereof. In certain embodiments, the resynchronization assistance information further includes location information indicating a geographical area where the resynchronization assistance information is valid.

In certain embodiments, the second configuration further indicates a set of candidate RACH groups, each RACH group assigned with a different post-switchover RACH occasion. In such embodiments, the processor may further select a candidate RACH group in a random manner and performing random access procedure at a post-switchover RACH occasion corresponding to the selected RACH group. In certain embodiments, the second configuration further indicates a RACH preamble to at the post-switchover RACH occasion.

Disclosed herein is a second apparatus for handling satellite hard feeder link switchover, according to embodiments of the disclosure. The second apparatus may be implemented by a UE device, such as the remote unit 105, the UE 515, the UE 705, and/or the user equipment apparatus 800, described above. The second apparatus includes a processor and a transceiver that receives a first configuration from a mobile communication network, where the network comprises a satellite, a first gateway (e.g., gNB) to which the satellite is connected, and a second gateway (e.g., gNB) to which the satellite is to connect in the future. Here, the first configuration indicates a transition period required by the satellite connected to the first gateway for feeder link switchover to the second gateway, the transition period defined by a transition time and a transition duration.

The transceiver further receives a second configuration from the network, said second configuration containing a threshold time before the transition time (i.e., before the start of feeder link switchover). The processor initiates a handover procedure to a new cell when the threshold time before the transition time is reached, where the new cell is not associated with the first satellite. In some embodiments, initiating the handover procedure includes selecting the new cell based on link measurements from a set of neighboring cells and expected beam dwelling time for the set of neighboring cells.

Disclosed herein is a first method for handling satellite hard feeder link switchover, according to embodiments of the disclosure. The first method may be performed by a UE device, such as the remote unit 105, the UE 515, the UE 705, and/or the user equipment apparatus 800, described above. The first method includes receiving a first configuration from a mobile communication network, where the network comprises a satellite, a first gateway (e.g., gNB) to which the satellite is connected, and a second gateway (e.g., gNB) to which the satellite is to connect in the future. Here, the first configuration indicates a transition period required by the satellite connected to the first gateway for feeder link switchover to the second gateway, the transition period defined by a transition time and a transition duration. The first method includes suspending communication with the mobile communication network at the transition time (i.e., pausing uplink and assuming there will be no downlink) and resuming communication with the mobile communication network after expiry of the transition duration.

In some embodiments, receiving the first configuration includes receiving the transition duration via higher layer signaling (e.g., RRC signaling and/or MAC CE). In such embodiments, the first method further includes receiving DCI that indicates the transition time, where a type of DCI received (i.e., whether UE-specific or group-common) is based at least in part on a type of cell (i.e., earth-fixed cell or earth-moving cell) serving the UE.

In some embodiments, receiving the first configuration includes receiving the transition duration and the transition time via group-common downlink control information. In some embodiments, resuming communication with the mobile communication network includes performing a RACH procedure. In such embodiments, the first method further includes receiving a second configuration from the network, said second configuration containing at least one of: A) resynchronization assistance information indicating at least one neighboring cell having a link to the second gateway; and B) a post-switchover RACH occasion.

In certain embodiments, the resynchronization assistance information comprises a set of cell identities for the at least one neighboring cell and a corresponding synchronization raster point (i.e., cell frequency of the neighboring cell) for each cell identity. In such embodiments, receiving the resynchronization assistance information may include receiving via one of: dedicated RRC signaling, common RRC signaling, MAC CE, broadcast signal, GC-DCI, or some combination thereof. In certain embodiments, the resynchronization assistance information further includes location information indicating a geographical area where the resynchronization assistance information is valid.

In certain embodiments, the second configuration further indicates a set of candidate RACH groups, each RACH group assigned with a different post-switchover RACH occasion. In such embodiments, the first method may further include selecting a candidate RACH group in a random manner and performing random access procedure at a post-switchover RACH occasion corresponding to the selected RACH group. In certain embodiments, the second configuration further indicates a RACH preamble to at the post-switchover RACH occasion.

Disclosed herein is a second method for handling satellite hard feeder link switchover, according to embodiments of the disclosure. The second method may be performed by a UE device, such as the remote unit 105, the UE 515, the UE 705, and/or the user equipment apparatus 800, described above. The second method includes receiving a first configuration from a mobile communication network, where the network comprises a satellite, a first gateway (e.g., gNB) to which the satellite is connected, and a second gateway (e.g., gNB) to which the satellite is to connect in the future. Here, the first configuration indicates a transition period required by the satellite connected to the first gateway for feeder link switchover to the second gateway, the transition period defined by a transition time and a transition duration.

The second method includes receiving a second configuration from the network, said second configuration indicating a threshold time before the transition time (i.e., before the start of feeder link switchover) and initiating a handover procedure to a new cell when the threshold time before the transition time is reached, where the new cell is not associated with the first satellite. In some embodiments, initiating the handover procedure include selecting the new cell based on link measurements from a set of neighboring cells and expected beam dwelling time for the set of neighboring cells.

Disclosed herein is a third apparatus for handling satellite hard feeder link switchover, according to embodiments of the disclosure. The third apparatus may be implemented by a network entity in a mobile communication network, such as the base unit 121, the NTN gateway 123, the satellite 130, the satellite 201, the GW1 203, the GW2 205, the satellite 301, the GW1 303, the GW2 305, the satellite 401, the GW1 403, the GW2 405, the satellite 501, the source NTN-GW 503, the target NTN-GW 505, the RAN node 507 (gNB-A), the satellite 601, the GW1/gNB1 603, the GW2/gNB2 605, the RAN node 707, and/or the network apparatus 900, described above. Here, it is assumed that the mobile communication network comprises a satellite, a first gateway (e.g., gNB) to which the satellite is connected, and a second gateway (e.g., gNB) to which the satellite is to connect in the future. The third apparatus includes a transceiver and a processor that creates a first configuration indicating a transition period required by the satellite connected to the first gateway for feeder link switchover to the second gateway, the transition period defined by a transition time and a transition duration. The transceiver sends the first configuration to at least one UE. The processor suspends communication with the at least one UE at the transition time (i.e., by pausing downlink and assuming there will be no uplink) and resumes communication with the at least one UE after expiry of the transition duration.

In some embodiments, the transition period is indicated by a current serving RAN node (i.e., gNB) to a group of UEs that are affected by switchover. In such embodiments, transmitting the first configuration includes sending the transition time and transition duration via one or more of: dedicated RRC signaling, common RRC signaling, MAC CE, broadcast signal, GC-DCI, or some combination thereof.

In some embodiments, the transition time is UE specific and is different for different UEs in the first cell. In such embodiments, the processor further determines a UE-specific transition time for a particular UE based upon mobility of the particular UE and a network connection of the particular UE.

In some embodiments, the transceiver further transmits a second configuration to the at least one UE, said second configuration containing at least one of: A) resynchronization assistance information indicating at least one neighboring cell having a link to the second gateway; B) a post-switchover RACH occasion. In certain embodiments, the processor further groups UEs in the first cell, where the RACH occasion is for a group of UEs and where the groups are selected to ensure that a number of UEs attempting for RACH procedure does not exceed a certain threshold.

Disclosed herein is a fourth apparatus for handling satellite hard feeder link switchover, according to embodiments of the disclosure. The fourth apparatus may be implemented by a network entity in a mobile communication network, such as the base unit 121, the NTN gateway 123, the satellite 130, the satellite 201, the GW1 203, the GW2 205, the satellite 301, the GW1 303, the GW2 305, the satellite 401, the GW1 403, the GW2 405, the satellite 501, the source NTN-GW 503, the target NTN-GW 505, the RAN node 507 (gNB-A), the satellite 601, the GW1/gNB1 603, the GW2/gNB2 605, the RAN node 707, and/or the network apparatus 900, described above. Here, it is assumed that the mobile communication network comprises a satellite, a first gateway (e.g., gNB) to which the satellite is connected, and a second gateway (e.g., gNB) to which the satellite is to connect in the future. The fourth apparatus includes a transceiver and a processor that creates a first configuration and a second configuration. The first configuration indicates a transition period required by the satellite connected to the first gateway for feeder link switchover to the second gateway, the transition period defined by a transition time and a transition duration. The second configuration contains a threshold time before the transition time (i.e., before to the start of feeder link switchover). The transceiver sends the first configuration and the second configuration to at least one UE.

The processor initiates a procedure to handover the at least one UE to a new cell when the threshold time before the transition time is reached, where the new cell is not associated with the first satellite. In some embodiments, initiating the handover procedure includes selecting the new cell based on link measurements from a set of neighboring cells and expected beam dwelling time for the set of neighboring cells.

Disclosed herein is a third method for handling satellite hard feeder link switchover, according to embodiments of the disclosure. The third method may be performed by a network entity in a mobile communication network, such as the base unit 121, the NTN gateway 123, the satellite 130, the satellite 201, the GW1 203, the GW2 205, the satellite 301, the GW1 303, the GW2 305, the satellite 401, the GW1 403, the GW2 405, the satellite 501, the source NTN-GW 503, the target NTN-GW 505, the RAN node 507 (gNB-A), the satellite 601, the GW1/gNB1 603, the GW2/gNB2 605, the RAN node 707, and/or the network apparatus 900, described above. Here, it is assumed that the mobile communication network comprises a satellite, a first gateway (e.g., gNB) to which the satellite is connected, and a second gateway (e.g., gNB) to which the satellite is to connect in the future. The third method includes transmitting a first configuration to at least one UE, the first configuration indicating a transition period required by the satellite connected to the first gateway for feeder link switchover to the second gateway, the transition period defined by a transition time and a transition duration. The third method includes suspending communication with the at least one UE at the transition time (i.e., by pausing downlink and assuming there will be no uplink) and resuming communication with the at least one UE after expiry of the transition duration.

In some embodiments, the transition period is indicated by a current serving RAN node (i.e., gNB) to a group of UEs that are affected by switchover. In such embodiments, transmitting the first configuration includes sending the transition time and transition duration via one or more of: dedicated RRC signaling, common RRC signaling, MAC CE, broadcast signal, GC-DCI, or some combination thereof.

In some embodiments, the transition time is UE specific and is different for different UEs in the first cell. In such embodiments, the third method further includes determining a UE-specific transition time for a particular UE based upon mobility of the particular UE and a network connection of the particular UE.

In some embodiments, the third method further includes transmitting a second configuration to the at least one UE, said second configuration containing at least one of: A) resynchronization assistance information indicating at least one neighboring cell having a link to the second gateway; B) a post-switchover RACH occasion. In certain embodiments, the third method further includes grouping UEs in the first cell, where the RACH occasion is for a group of UEs and where the groups are selected to ensure that a number of UEs attempting for RACH procedure does not exceed a certain threshold.

Disclosed herein is a fourth method for handling satellite hard feeder link switchover, according to embodiments of the disclosure. The fourth method may be performed by a network entity in a mobile communication network, such as the base unit 121, the NTN gateway 123, the satellite 130, the satellite 201, the GW1 203, the GW2 205, the satellite 301, the GW1 303, the GW2 305, the satellite 401, the GW1 403, the GW2 405, the satellite 501, the source NTN-GW 503, the target NTN-GW 505, the RAN node 507 (gNB-A), the satellite 601, the GW1/gNB1 603, the GW2/gNB2 605, the RAN node 707, and/or the network apparatus 900, described above. Here, it is assumed that the mobile communication network comprises a satellite, a first gateway (e.g., gNB) to which the satellite is connected, and a second gateway (e.g., gNB) to which the satellite is to connect in the future. The fourth method includes transmitting a first configuration to at least one UE, the first configuration indicating a transition period required by the satellite connected to the first gateway for feeder link switchover to the second gateway, the transition period defined by a transition time and a transition duration. The fourth method includes transmitting a second configuration to the at least one UE, said second configuration containing a threshold time before the transition time (i.e., before the start of feeder link switchover).

The fourth method includes handing over the at least one UE to a new cell when the threshold time before the transition time is reached, where the new cell is not associated with the first satellite. In some embodiments, initiating the handover procedure includes selecting the new cell based on link measurements from a set of neighboring cells and expected beam dwelling time for the set of neighboring cells.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method at a User Equipment (“UE”) comprising:
receiving a first configuration from a mobile communication network comprising a satellite, a first gateway to which the satellite is connected, and a second gateway, said first configuration indicating a transition period required by the satellite connected to the first gateway for feeder link switchover to the second gateway, the transition period defined by a transition time and a transition duration;
suspending communication with the mobile communication network at the transition time; and
resuming communication with the mobile communication network after expiry of the transition duration.

2. The method of claim 1, wherein receiving the first configuration comprises receiving the transition duration via higher layer signaling, the method further comprising receiving downlink control information (“DCI”) that indicates the transition time, wherein a type of DCI received is based at least in part on a type of cell serving the UE.

3. The method of claim 1, wherein receiving the first configuration comprises receiving the transition duration and the transition time via group-common downlink control information.

4. The method of claim 1, wherein resuming communication with the mobile communication network comprises performing a random-access procedure (“RACH procedure”), the method further comprising receiving a second configuration from the network, said second configuration comprising at least one of:
resynchronization assistance information indicating at least one neighboring cell having a link to the second gateway; and
a post-switchover random access channel occasion (“RACH occasion”).

5. The method of claim 4, wherein the resynchronization assistance information comprises a set of cell identities for the at least one neighboring cell and a corresponding synchronization raster point for each cell identity, wherein receiving the resynchronization assistance information comprises receiving via one of: dedicated Radio Resource Control (“RRC”) signaling, common RRC signaling, Medium Access Control (“MAC”) Control Element (“CE”), broadcast signal, group-common Downlink Control Information (“DCI”), or some combination thereof.

6. The method of claim 5, wherein the resynchronization assistance information further comprises location information indicating a geographical area where the resynchronization assistance information is valid.

7. The method of claim 4, wherein the second configuration further indicates a set of candidate RACH groups, each RACH group assigned with a different post-switchover RACH occasion, the method further comprising selecting a candidate RACH group in a random manner and performing random access procedure at a post-switchover RACH occasion corresponding to the selected RACH group.

8. The method of claim 4, wherein the second configuration further indicates a RACH preamble to at the post-switchover RACH occasion.

9. A User Equipment (“UE”) apparatus comprising:
a transceiver that:
receives a first configuration from a mobile communication network comprising a satellite, a first gateway to which the satellite is connected, and a second gateway, said first configuration comprising a transition period required by the satellite connected to the first gateway for feeder link switchover to the second gateway, the transition period defined by a transition time and a transition duration; and
receiving a second configuration from the network, said second configuration comprising a threshold time before the transition time; and
a processor that initiates a handover procedure to a new cell when the threshold time before the transition time is reached, wherein the new cell is not associated with the first satellite.

10. The apparatus of claim 9, wherein initiating the handover procedure comprises selecting the new cell based on link measurements from a set of neighboring cells and expected beam dwelling time for the set of neighboring cells.

11. A network apparatus in a mobile communication network that contains a satellite, a first gateway to which the satellite is connected, and a second gateway, the apparatus comprising:
a transceiver that transmits a first configuration to at least one User Equipment (“UE”) in a first cell, said first configuration indicating a transition period required by the satellite connected to the first gateway for feeder link switchover to the second gateway, the transition period defined by a transition time and a transition duration; and
a processor that:
suspends communication with the at least one UE at the transition time; and
resumes communication with the at least one UE after expiry of the transition duration.

12. The apparatus of claim 11, wherein the transition period is indicated by a current serving Radio Access Network (“RAN”) node to a group of UEs that are affected by switchover, wherein transmitting the first configuration comprises sending the transition time and transition duration via one or more of: dedicated Radio Resource Control (“RRC”) signaling, common RRC signaling, Medium Access Control (“MAC”) Control Element (“CE”), broadcast signal, group-common Downlink Control Information (“DCI”), or some combination thereof.

13. The apparatus of claim 11, wherein the transition time is UE specific and is different for different UEs in the first cell, wherein the processor further determines a UE-specific transition time for a particular UE based upon mobility of the particular UE and a network connection of the particular UE.

14. The apparatus of claim 11, wherein the transceiver further transmits a second configuration from the at least one UE, said second configuration comprising at least one of:
resynchronization assistance information indicating at least one neighboring cell having a link to the second gateway; and
a post-switchover random access channel (“RACH”) occasion; and
a threshold time before the transition time.

15. The apparatus of claim 14, wherein the processor further groups UEs in the first cell, wherein the RACH occasion is for a group of UEs, wherein the groups are selected to ensure that a number of UEs attempting for RACH procedure does not exceed a certain threshold.
